(19) United States
(12) Patent Application Publication
(10) Pub. No.: US 2023/0071597 A1
(43) Pub. Date: Mar. 9, 2023

(54) PLATE FOR AN ELECTROCHEMICAL, MEDIA-GUIDING SYSTEM, CONTACT ELEMENT, AND TRANSMISSION DEVICE AS WELL AS METHOD FOR THEIR PRODUCTION

(71) Applicant: Reinz-Dichtungs-GmbH, Neu-Ulm (DE)

(72) Inventors: Andre SPEIDEL, Neu-Ulm (DE); Stephan WENZEL, Neu-Ulm (DE); Bernd GAUGLER, Neu-Ulm (DE)

(21) Appl. No.: 17/930,939

(22) Filed: Sep. 9, 2022

(30) Foreign Application Priority Data
Sep. 9, 2021 (DE) 20 2021 104 874.3

(51) Int. Cl. H01M 8/0258; H01M 8/0247; H01M 8/0232

(52) U.S. Cl. CPC H01M 8/0258; H01M 8/0247; H01M 8/0232

(57) ABSTRACT

An electrochemical, media-guiding system, a contact element for electrically and mechanically contacting such a plate, and a transmission device containing such a contact element. The present disclosure further relates to the production of such a plate or such a contact element. A plate having at least one contact point forming a voltage take-off point, a current supply point, and/or a current take-off point. The at least one contact point having a laser-surface-treated region.

### CROSS-REFERENCE TO RELATED APPLICATION

The present application claims priority to German Utility Model Application No. 20 2021 104 874.3, entitled “PLATE FOR AN ELECTROCHEMICAL, MEDIA-GUIDING SYSTEM, CONTACT ELEMENT, AND TRANSMISSION DEVICE AS WELL AS METHOD FOR THEIR PRODUCTION”, and filed on Sep. 9, 2021. The entire contents of the above-listed application is hereby incorporated by reference for all purposes.

### TECHNICAL FIELD

The present disclosure relates to a plate for an electrochemical, media-guiding system, to a contact element for electrically and mechanically contacting such a plate, and to a transmission device containing such a contact element. The present disclosure further relates to the production of such a plate or such a contact element.

### BACKGROUND AND SUMMARY

By way of example, the plate can be used for a fuel cell system, in which electrical energy is obtained from hydrogen and oxygen. Alternatively, the plate can be used for an electrolyzer system, in which hydrogen and oxygen are produced from water using electric energy.

On the one hand, plates for an electrochemical system usually comprise bipolar plates featuring two metal separator plates, wherein in each case two of these bipolar plates bound an electrochemical cell, that is to say for example a fuel cell. In the narrower sense, one separator plate belongs to one cell and the other separator plate of the bipolar plate already belongs to the next cell. In an electrochemical system, usually a plurality of electrochemical cells, for example up to 400, are stacked in series to form a stack. The cells themselves usually comprise, in addition to two half bipolar plates in each case, a membrane electrode assembly, also referred to as an MEA, which is arranged between the half bipolar plates, as well as a gas diffusion layer (GDL), made for example of electrically conductive carbon fleece, on both sides of the MEA. The entire stack is held together between two end plates by way of a clamping system and is compressed to a predetermined extent.

Besides bounding the electrochemical cells, the bipolar plates have a number of additional functions in an electrochemical system: on the one hand, electrically contacting the electrodes of the various electrochemical cells and transmitting the current onwards to the respectively adjacent cell, and on the other hand supplying the cells with the reaction media and disposing of the reaction products, and also cooling the electrochemical cells and transmitting the waste heat onwards, as well as sealing off the compartments of the two different reaction media and the coolant with respect to one other and with respect to the outside.

Through-openings for reaction media, that is to say in the case of fuel cells usually on the one hand hydrogen or methanol and on the other hand air or oxygen, as well as coolants, usually mixtures of demineralized water and antifreeze agents, are accordingly formed in the two metal separator plates of the bipolar plate in order to supply the electrochemical cells. Furthermore, a distributing structure is formed in each of the two metal separator plates, with channels being formed on both surfaces of the two separator plates. A respective reaction medium is guided on each of the outward-facing surfaces of the bipolar plate, and the coolant is guided in the intermediate space between the two metal separator plates. The region that coincides with the actual membrane, and not with the edge region or sealing structure thereof, in an orthogonal projection into a common plane with the MEA, is also referred to as the electrochemically active region of the plate. In this electrochemically active region of the plate, a reaction medium is guided in a channel structure on the surface of the plate that faces towards the MEA. Usually, the electrochemically active region is adjoined on both sides by a distribution region that likewise has channel-like distributing structures. Each of the distributing structures communicates with at least two of the through-openings, namely at least one inlet and at least one outlet for the respective fluid. For sealing with respect to the outside, a sealing element is arranged in each of the metal separator plates, extending in a closed manner at least around the electrochemically active region of the plate and optionally around at least some of the through-openings, said sealing element being arranged at a distance from the electrochemically active region or the relevant rim of the through-opening. In addition, for sealing with respect to one another, individual through-openings may also be sealed off by a sealing element extending in an intrinsically closed manner around the respective through-opening.

The metals used for the plates are designed for the aggressive conditions that prevail in the media-guiding regions of the electrochemical system. However, this means that those metals which are an option from an economic point of view, and which are suitable for the aggressive conditions, have a tendency towards passivation. By way of example, stainless steel forms a passivation layer of chromium oxide, and only then is corrosion resistance obtained, such as for the media-guiding regions.

In order to check whether the electrochemical cells deliver a sufficient cell voltage (individual cell voltage measurement=CVM), the individual cells are electrically and mechanically contacted by a contact element in the region of a contact point at the edge of the separator plates, outside of the media-guiding region. Often, however, the contact resistance between the contact point and the contact element is very high, for example because only an insufficiently large contact area forms between the contact point and the contact element or because at least the surface of the contact point or of the contact element has an unacceptably high contact resistance due to the aforementioned passivation layer. This is partially counteracted by providing the contact point and/or the contact element with a conductive coating, for example a gold coating, but this is associated with high costs for the large number of contact areas in an electrochemical system. The current supply for electrolyzer systems can make use of contact elements, too.

On the other hand, plates for an electrochemical system usually also comprise a current collector plate adjacent to each of the end plates, as well as a separator plate designed as a unipolar plate adjacent to each of these current collector plates and remote from the end plate, wherein the current collector plate serves to transmit the current generated in the electrochemical system to a consumer or to introduce the current that is required in the electrochemical system. A unipolar plate may in this case be designed in a manner similar to a separator plate of a bipolar plate. The current collector plate is usually a plate that is flat at least over large portions, which may have, for example on its side edge or towards the end plate, projections or other extensions that serve to transmit the current onwards. The current collector plate usually in part bears flat against the unipolar plate. A contact layer having a structure comparable to a gas diffusion layer may also be arranged in this intermediate space. The remaining intermediate space between the unipolar plate and the current collector plate usually does not have media flowing through it, but media does flow over the surface of the unipolar plate that faces away from the end plate. Here, too, a low contact resistance at the contact area between the current collector plate and the unipolar plate is beneficial for continuously efficient operation of the electrochemical system.

Further, plates for an electrochemical system in the case of an electrolyzer also comprise current supply plates arranged at the end or close to the end of an electrolyzer stack, which current supply plates provide electrical current to the last (or first) media distribution plate of the electrolyzer stack for the production of hydrogen and oxygen from water, where this media distribution plate is arranged adjacent to the respective current supply plate. The current supply plates may be separate plates, which come to rest on the actual end plates of the stack, the end plates mainly serving for compressing the stack. In the same way, it is however also possible to integrate the current supply function into the end plates or to design the end plates as current supply plates. The current supply plate is usually a plate that is flat at least over large portions. The current supply plate may comprise projections or other protrusions on its surface pointing away from the center of the stack—or in case of a current supply plate separate from the endplate—facing the endplate or passing through an opening in the end plate, which projections or protrusions serve for the supply of electrical current. In the same way, the current supply plates or end plates serving as current supply plates may comprise openings, which serve for the take-up of a plug, a cable, or the like. As before, a low contact resistance at the contact area between the current supply plate and the media distribution plate is beneficial for continuously efficient operation of the electrochemical system. For instance, if the interface of the current supply plate on the one hand and of the plug, cable etc. on the other hand has a low contact resistance.

A passivation layer thus leads to a significantly increased electrical contact resistance at the aforementioned contact areas, reduces the conduction of current between the unipolar plate and the current collector plate, and/or reduces the voltage transmission in the region of the individual cell voltage measurement.

It is therefore an object of the present disclosure to specify a plate for an electrochemical, media-guiding system that solves at least one of the aforementioned problems. A further object of the present disclosure is to specify a contact element for electrically and mechanically contacting such a plate, a transmission device containing such a contact element, and an electrochemical system, which likewise solve at least one of the aforementioned problems.

This object is achieved by embodiments of the plate, the contact element, the transmission device and the electrochemical system described herein. Advantageous embodiments of the present disclosure will become apparent through the description below.

On the one hand, therefore, a plate for an electrochemical, media-guiding system is provided. The plate may be designed as a separator plate, such as a separator plate of a bipolar plate, as a unipolar plate, as a media distribution plate, as a current supply plate or as a current collector plate. The plate comprises at least one contact point designed as a voltage take-off point, one contact point designed as a current supply point and/or one contact point designed as a current take-off point, which contact point has a laser-surface-treated region. The contact point is arranged in a non-media-guiding region of the plate.

On the other hand, a contact element for electrical and mechanical connection to a contact point of an electrochemical system is provided, wherein the contact element has a laser-surface-treated region. The connection between the contact element according to the present disclosure and a contact point may take place in a force-fitting and/or form-fitting manner. The contact point may be designed as mentioned above; a laser surface treatment is possible here, but is not necessary.

The laser-treated surfaces of the at least one plate or of the at least one contact element, respectively, may be made from stainless steel.

The laser treatment of the aforementioned regions of the surface of the plate and/or of the contact element may lead to a structuring of the regions in question. For instance, the at least one laser-surface-treated region may have periodic surface structures. The surface structures created by laser treatment may lead to a reduction in the electrical contact resistance and/or to an increase in the electrical conductivity. The plate and/or the contact element may thus have a greater electrical conductivity and/or a lower electrical resistance in the region of the periodic surface structures than outside of the periodic surface structures.

Usually, the surface structures are arranged periodically in relation to one another at least in one spatial direction. The surface structures may also be arranged periodically with respect to one another in two spatial directions. According to some embodiments, the surface structures at least in some sections are arranged in parallel next to one another and/or in parallel one behind the other. The alignment may exist over relatively large or relatively small regions. For instance, the surface structures extend parallel to one another at least within a region enclosed by a grain boundary. Different regions containing parallel surface structures, but in which there is a different orientation compared to another region, may also adjoin one another, for example at grain boundaries.

The shape of the structures on the surface thus repeats in at least one spatial direction. The spatial period typically denotes the maximum spacing between two adjacent surface structures of identical or similar shape. For reasons linked to production, the surface structures are usually not completely identical to one another. Rather, the period may be subject to fluctuations along the surface. A mean spatial period is therefore specified, which is less than 10 μm. It may also happen that the spatial period of the surface structures is in any case less than 10 μm.

Such periodic surface structures are typically created by means of laser radiation from an ultra-short pulse laser (see below) and are also known in the literature as “Laser-induced Periodic Surface Structures” (LIPSS). For further explanations, details and definitions regarding LIPSS, reference is made to the following publication: “Dynamik der Erzeugung and Mechanismen der Entstehung von periodischen Oberflächenstrukturen im Nanometerbereich (LIPSS) durch die Bestrahlung von Festkörpern mit Femtosekunden-Laserpulsen” [“Dynamics of creation and mechanisms of formation of periodic surface structures in the nanometre range (LIPSS) by irradiation of solids with femtosecond laser pulses”], dissertation by Sandra Hohm, Berlin, 2014 (hereinafter: Hohm 2014), which is fully incorporated as part of this disclosure by way of reference. The plate, the contact element and/or the transmission device are thus typically laser-surface-treated in the region of the periodic surface structures. In this case, the spatial period of the surface structures may be directly dependent on the wavelength of the laser light used and usually lies in the order of magnitude of the wavelength of the laser light used.

The inventors have found that the aforementioned surface structures may be suitable for use on surface portions of plates, contact elements and/or transmission units of an electrochemical system. Specifically, by virtue of the periodic surface structures, surface properties of at least one plate, one contact element and/or one transmission unit can be modified in a targeted manner. By way of example, chemical and/or electrical properties of the surface can be influenced and/or improved by virtue of the surface structures.

For reasons of linguistic simplification, the term “article” will be used hereinafter as a collective term for at least one plate, one contact element and/or one transmission unit.

The surface structures on such an article may extend, for example, in a wavy or linear manner along their longitudinal direction. In one embodiment, the surface structures may comprise depressions and/or elevations. The depressions may extend between the elevations and are usually delimited and/or formed by the latter. At least in some sections, the depressions and/or elevations may extend substantially parallel to one another (for example in parallel next to one another or one behind the other). The surface structures often form, at least locally, a trench structure comprising a plurality of elongated depressions which are oriented substantially parallel to one another. The number of surface structures, depressions and/or elevations can be varied according to requirements. For instance, the number of depressions may depend on the size of the surface that is to have the surface structures. In a region containing similar or identical surface structures, there are typically at least 10 or at least 20 trench structures, for example depressions, which extend parallel to one another at least in some sections. It is also possible to provide a different number of periods over a certain length in different regions in at least one spatial direction on the surface.

The dimensions of the depressions, for example the period, usually depend at least on the wavelength of the laser radiation used. By way of example, the depressions have a depth of at least 8 nm, for example at least 20 nm, for example at least 50 nm, and/or at most 3 μm, at most 1 μm, for example at most 500 nm, and/or at most 300 nm, usually at most 250 nm. The depth is usually measured normal to the surface area formed by the elevations and/or normal to the surface of the article that is free of the periodic surface structures. Furthermore, the depressions may have a width of at least 0.1 μm and/or at most 2 μm. The width is typically measured at half height and perpendicular to the local longitudinal direction of the depressions. In addition, the depressions may have a period in one spatial direction of at least 100 nm, usually at least 0.3 μm and/or at most 3 μm, at most 1.5 μm, for example at most 1.2 μm, for example at most 1000 nm, typically at most 700 nm. The periodic surface structures thus often comprise nanostructures having a depth, width and/or period of in each case less than one micrometre or, for instance with regard to the period, slightly more than one micrometre. For instance, if the surface structures are at least in part arranged periodically in relation to one another at least in one spatial direction (x, y).

For example, the plate or the contact element is formed from a metal sheet, such as from a stainless-steel sheet. However, separator plates and unipolar plates have a smaller sheet thickness, usually of 50-200 μm, than current collector plates or current supply plates, which usually have a sheet thickness of 0.8-4 mm. Media distribution plates in electrolyzer system often have a thickness between the two ranges mentioned above, thus their thickness usually is 200-800 μm.

The plate may be designed as a separator plate of a bipolar plate or as a unipolar plate. It may be a media-guiding inner region, a non-media-guiding outer region, and at least one sealing element that seals off the media-guiding inner region with respect to the non-media-guiding outer region. The contact point may be provided in the outer region.

The contact point may be designed for electrical and mechanical, such as force-fitting and/or form-fitting, connection to a transmission device. In a first variant, the contact point has for this purpose a socket for a plug-in element of the transmission device. In a second variant, the contact point has for this purpose a plug-in element that can be received in a socket of the contact element of the transmission device.

The socket of the contact point of the aforementioned first variant may be formed in at least one or in both separator plates of a bipolar plate and in this case may form a channel that starts at the outer edge of the plate in question, the closed end of which channel may be arranged at a distance from the sealing element and has a smaller height than the sealing element. In addition, the two separator plates may at least in part be connected, for example welded, in the vicinity of this socket. Said socket may also be adapted to the shape of the plug-in element of the transmission device that is to be received and may have tabs, embossments, etc. The connection of the plate and socket might improve the mechanical connection and stability.

In its simplest embodiment, the plug-in element of the second variant may be formed as a tab, which protrudes beyond the outer edge of the plate and is formed in a manner extending from the material of the plate. However, it may also be mechanically reinforced by embossments, bends or other shapings.

In a manner complementary to the aforementioned two variants of the contact point of a plate or a common contact point of two separator plates that form a bipolar plate, the contact element of the transmission unit may be designed as a plug-in element to be received in a socket of the contact point of the plate or as a socket for a plug-in element of the plate. The embodiments of a socket or plug-in element that were mentioned for the contact point may be used analogously here.

For instance, in the case of a current collector plate, a current supply plate, a media distribution plate or a unipolar plate, the contact point may be designed as a flat region that extends at least in part, for example entirely, along a flat side of the plate. In the case of a current collector plate or current supply plate, this may be a flat, substantially planar, for example non-structured region that extends across the entire surface or at least as far as edge structures along one flat side of the plate, for instance along the flat side of the plate that faces towards the unipolar plate. In the case of a unipolar plate, these may be portions of the embossed structure which, on the flat side of the unipolar plate that faces towards the current collector plate, project in the direction of the current collector plate and come into contact with the surface of the current collector plate, optionally with the interposition of a diffusion layer. The intermediate space between the unipolar plate and the current collector plate is in this case for instance not media-guiding.

Even when there is facial contact between the contact element and the contact point, it may be that the two elements are connected to one another in a force-fitting and/or form-fitting manner. Between a current collector plate and a unipolar plate, use may be made of a force-fitting connection, which may not only be designed as a force-fitting connection between this pair of two plates alone, but rather as a clamping of the entire plate stack, for example by means of tensioning straps and/or screw connections.

Furthermore, the present disclosure also relates to a transmission device for use in measuring an electrical voltage and/or in transmitting an electrical current onwards from at least one sub-region of an electrochemical system, comprising an above-described contact element.

As mentioned above, the surface structures may lead to a significant reduction in the electrical contact resistance and/or to a significant increase in the electrical conductivity both in the plates, in the contact elements, and in the transmission devices or portions thereof. For instance, an electrical conductivity is greater in the laser-surface-treated region than outside of the laser-surface-treated region.

The present disclosure also encompasses an electrochemical system comprising at least one of the “articles”, that is to say comprising at least one plate, one contact element and/or one transmission unit.

In one embodiment, the electrochemical system is formed with two current collector plates, wherein a plurality of stacked separator plates are arranged between the first and second current collector plate. In this case, too, it may be advantageous if the electrochemical system comprises a transmission unit.

In another embodiment, the electrochemical system is formed with two current supply plates, wherein a plurality of stacked media distribution plates is arranged between the first and second current supply plate. The contact element here may be realized as a screw or the like in the end plates or current supply plates.

Steps of a method for producing an above-described article, that is to say a separator plate (for instance a unipolar plate or a separator plate of a bipolar plate), a media distribution plate, a current collector plate, a current supply plate, a contact element or a transmission system, will be described below.

According to a first aspect, such a method for producing the above-described article may comprise, for example, at least the following steps:

a method for producing a plate for an electrochemical, media-guiding system, comprising the steps:
providing a plate that has at least one contact point designed as a voltage take-off point, one contact point designed as a current supply point, and/or one contact point designed as a current take-off point, which contact point is arranged in a non-media-guiding region of the plate,
irradiating the contact point by means of a pulsed laser, a pulse duration of the laser pulses being less than 1 ns, for example less than 100 ps, and/or less than 50 ps,
creating periodic surface structures on the contact point by means of the laser radiation.

According to a second aspect, such a method for producing the above-described article may comprise, for example, at least the following steps:
a method for producing a contact element for mechanical and electrical connection to a contact point of a plate of an electrochemical system, the method comprising the steps:
   irradiating the contact element by means of a pulsed laser, a pulse duration of the laser pulses being less than 1 ns, for example less than 100 ps, and/or less than 50 ps,
   creating periodic surface structures on the contact element by means of the laser radiation.

Instead of plates of an electrochemical system, or in addition to these, contact elements or parts of a transmission system can also be produced analogously. The periodicity of the surface structures need not be uniform across the entire laser-irradiated region; it may also refer only to a region within a grain boundary.

During the laser treatment according to the first and/or second aspect, the aforementioned plurality of periodic surface structures is typically created within a spatially contiguous projection of the respective laser pulse onto the article. A plurality of periodic surface structures can be created per laser pulse. The creation of each periodic surface structure by the respective laser pulse can be completed before the next laser pulse hits. At least 5 or at least 10 or at least 20 periodic surface structures, that is to say trench structures, may be created per laser pulse. The periodic surface structures are thus created by each laser pulse within the contiguou s surface irradiated by the respective laser pulse and not, for example, as a result of the article being scanned in a spatially periodic manner or being irradiated with a spatially periodic, non-contiguous light pattern such as a diffraction pattern or interference pattern.

In this case, it is advantageous that the laser pulses have a pulse duration of less than 1 ns, for example less than 100 ps, for example less than 10 ps, or for example less than 1 ps. For instance, the laser pulses have a pulse rate of 1 MHz or less. For instance, it is advantageous if the ratio of pulse rate to pulse duration is at least 1000. Due to this short pulse duration and the comparatively low pulse rate, on the one hand very high intensities can be achieved, which is required for cold ablation of the surface and/or rearrangement of the surface material. On the other hand, the short pulse duration in conjunction with the considerable dead times enables the surface material to be machined in a manner largely free of heat diffusion, and thus makes it possible to create the periodic surface structures.

The pulse duration may be less than 100 ps, less than 50 ps, less than 20 ps, less than 10 ps, or even less than 1 ps. Pulse durations in the fs range can also be used, for example greater than 30 fs and/or less than 1000 fs and/or less than 500 fs, for example greater than 50 fs and/or greater than 100 fs. For instance, picosecond or femtosecond lasers can be used for the method, these being referred to collectively as ultrashort-pulse lasers.

The surface structures usually have the form of a periodic trench structure, the shape of which depends on the process parameters. Possible process parameters are disclosed for example in Hohm 2014.

For instance, the periodic surface structures may be created as a result of the incident laser radiation interacting with the irradiated surface. In this case, the periodic surface structures are typically created through optical interference of the incident laser radiation by an electromagnetic surface wave generated by the laser pulse in the material used. Typically, a fluence of the laser radiation lies in the order of magnitude of the ablation threshold of the material used. The fluence of the laser light is often at least so great that cold ablation of the material is possible. For example, the fluence may be selected in such a way that it deviates by no more than 20% from the ablation threshold of the material used. The fluence is a measure of the energy density of the laser pulses and is usually specified in J/cm². The fluence may be for example at least 0.001 J/cm², at least 0.01 J/cm² or at least 0.1 J/cm² and/or at most 10.0 J/cm², at the most 5.0 J/cm², at the most 2.0 J/cm². The repetition rate of the laser may be, for example at least 10 Hz, for example at least 1 kHz and/or at most 1000 kHz, for example at most 20 kHz. The low repetition rate results in considerable dead times, so that the total energy input is limited and only the surface layer is modified.

For instance, the laser radiation is linearly polarized. The surface structures are typically oriented perpendicular to a polarization direction of the incident laser radiation. This may apply to core regions of the irradiated region and for example to regions that extend within the grain boundaries of the untreated sheet or metal part. In contrast, the surface structures may be oriented differently in regions which adjoin one another, but which are separated from one another by a grain boundary. A mean spatial period of the surface structures may be at least 2%, for example at least 5%, for example at least 20%, and/or at most 200%, for example at most 120%, of the laser wavelength used. The plate, the contact element or the part of a transmission device may thus have different regions, each with a periodic structuring but with a different orientation in the different regions. In this case, the aforementioned regions may adjoin one another, but they may also be spaced apart from one another by non-structured regions.

The most common LIPSS are referred to in the literature as “Low Spatial Frequency LIPS S” (LSFLs) (see Hohm 2014). LSFLs have an orientation perpendicular to the polarization of the laser beam and a period in the region of the wavelength of the laser used. By virtue of the angle of incidence relative to the surface, it is possible both for the period to be varied as a result of the projection and for the orientation of the LIPSS to be rotated through an angle of up to 90°. It has been reported in the literature that the period P of LSFLs lies in the order of magnitude of the wavelength λ of the incident laser radiation (cf. Hohm 2014), for example P≈λ, A second type of LIPSS, the so-called HSFLs (“High Spatial Frequency LIPSS”), have significantly smaller periods PHSFL compared to the laser wavelength (PHSFL <<λ). The orientation thereof is coupled to the polarization of the radiation in a manner depending on the material, and is usually oriented either parallel or perpendicular thereto.

According to this variant, the surface structures are created by means of a single laser beam. The surface to be machined can be successively scanned by the laser beam.

The laser beam or laser pulse hitting the article to be machined may have a beam diameter or a smallest lateral dimension of at least 20 μm, for example at least 40 μm. In other words, the contiguous projection of the laser beam onto the article, which can also be referred to as a laser spot, laser dot or laser point, may have the aforementioned beam diameter or the aforementioned smallest lateral dimension of at least 20 μm, for example at least 40 μm. When using a line laser or linear laser, the laser line may have a width (smallest lateral dimension) of at least 20 μm, for example at least 40 μm.

In a further variant, at least two laser beams, such as at least two linearly polarized laser beams, are superimposed. By superimposing the laser beams, an interference pattern can be formed in order to create the surface structures. A diffraction pattern can also be used to create the surface structures. By using the interference pattern or diffraction pattern, the surface of the article is not scanned by just one laser beam. Overall, therefore, the method can be carried out much more quickly. For this purpose, the laser beam of a laser may be split into two partial beams. The interference pattern or diffraction pattern usually comprises a plurality of spatially non-contiguous light spots. It should be noted here that the spatial period of the periodic surface structures is brought about not by the spatial period of the interference pattern or diffraction pattern of the laser radiation, but rather by the interaction of the short laser pulse with the article, see also above. The spatial period of the surface structures therefore deviates from the spatial period of the interference pattern or diffraction pattern of the laser radiation and is usually much smaller, for example 10 times smaller.

It should be noted that, according to the aforementioned method, the steps of forming the socket and irradiating the plate or the contact element of the plate by means of the pulsed laser can be swapped. It may therefore be provided that the surface structuring takes place prior to or after the shaping of the sheet. The socket is typically formed, for example jointly with other structures of the plate, by deep-drawing, hydroforming or embossing the plate.

Exemplary embodiments of a plate for an electrochemical, media-guiding system, of a contact element and of a transmission device, as well as of an electrochemical system, are shown in the figures and will be explained in greater detail on the basis of the following description.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 schematically shows a perspective view of an electrochemical system comprising a plurality of bipolar plates and two unipolar plates.

FIG. 2 schematically shows, in a perspective view, two bipolar plates for an electrochemical system of the type shown in FIG. 1 and a membrane electrode assembly arranged between the bipolar plates.

FIGS. 3A and 3B show a sectional view through a contact point of a separator plate and a contact element of a transmission device.

FIGS. 4A and 4B show a sectional view through a contact point of a separator plate and a contact element of a transmission device.

FIG. 4C shows a sectional view of a contact element.

FIG. 5 shows a sectional view through a contact point of a separator plate and a contact element of a transmission device.

FIG. 6 shows a sectional view through a contact point of a separator plate and a contact element of a transmission device.

FIG. 7A shows a plan view of a transmission device with multiple contact elements.

FIG. 7B shows a sectional view of the transmission device of FIG. 7A with plug-in elements of the contact points of separator plates received therein.

FIG. 7C schematically shows a plan view of a plug-in element of a contact point from FIG. 7B.

FIG. 8A shows a sectional view of part of an electrochemical system.

FIG. 8B shows a sectional view of part of an electrochemical system.

FIG. 9A shows a microscopic image of periodic surface structures in plan view.

FIG. 9B shows a detail from FIG. 9A.

FIG. 10 shows a microscopic image of periodic surface structures in plan view.

FIG. 11A schematically shows part of a separator plate in a perspective view.

FIG. 11B schematically shows part of a separator plate in a perspective view.

FIG. 12A shows a detail of part of an article.

FIG. 12B shows a detail of part of an article.

FIG. 12C shows a detail of a plan view of an article.

FIG. 12D shows a detail of a cross-section of an article.

FIG. 12E shows a detail of a plan view of an article.

FIG. 13 schematically shows, in a perspective view, a laser system for creating periodic surface structures.

FIG. 14A schematically shows a cross-section of the laser system of FIG. 13.

FIG. 14B shows a detail of the laser system of FIGS. 13 and 14A.

FIG. 15 shows resistance measurements at the transition point between two (optionally treated) stainless steel sheets.

FIG. 16 shows resistance measurements at the transition point between two (optionally treated) stainless steel sheets with a carbon fleece positioned therebetween.

FIGS. 1-14A are shown approximately to scale. Here and below, features that recur in different figures are denoted by the same or similar reference signs in each case.

### DETAILED DESCRIPTION

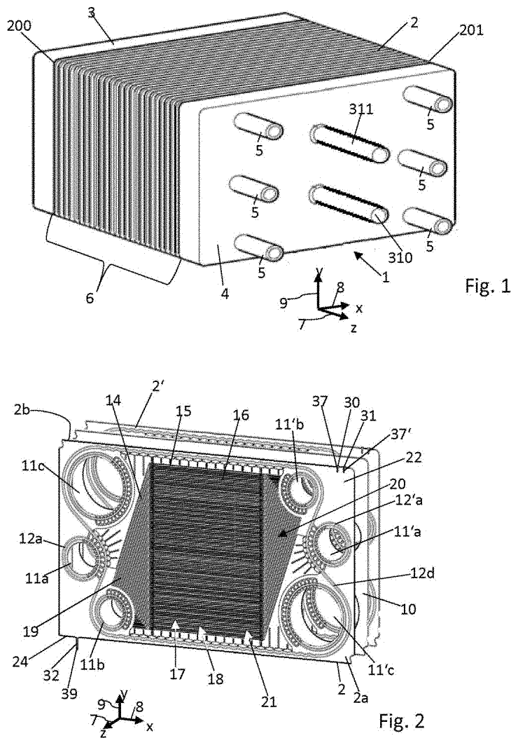

FIG. 1 shows an electrochemical system 1 of the type proposed here, comprising a plurality of structurally identical metal bipolar plates 2 which are arranged in a stack 6 and are stacked along a z-direction 7. The bipolar plates 2 of the stack are clamped between two end plates 3, 4. A unipolar plate 200, 201 is arranged between each of the end plates 3, 4 and the bipolar plate stack 6. The current collector plate arranged between an end plate 3, 4 and the adjacent unipolar plate 200, 201 is not visible in FIG. 1, but the projections 310, 311 of a current collector plate that protrude through the end plate 4 are visible. The z-direction 7 will also be referred to as the stacking direction. The bipolar plates 2 usually comprise in each case two metal separator plates 2a, 2b which are connected to one another (see, for example, FIG. 2). In the present example, the system 1 is a fuel cell stack. Each two adjacent bipolar plates 2 of the stack therefore enclose between them an electrochemical cell, which serves for example to convert chemical energy into electrical energy. The electrochemical cells usually each comprise a membrane electrode assembly (MEA) 10 (see, for example, FIG. 2). Each MEA typically contains at least one membrane, for example an electrolyte membrane. Furthermore, a gas diffusion layer (GDL) may be arranged on one or both surfaces of the MEA.

The z-axis 7, together with an x-axis 8 and a y-axis 9, spans a right-handed Cartesian coordinate system. The bipolar plates 2 and separator plates 2a, 2b each define a plate plane, wherein the plate planes of the separator plates 2a, 2b are each oriented parallel to the x-y plane and thus perpendicular to the stacking direction or to the z-axis 7. The end plate 4 has a plurality of media ports 5, via which media can be supplied to the system 1 and via which media can be discharged from the system 1. These media that can be supplied to the system 1 and discharged from the system 1 may comprise for example fuels such as molecular hydrogen or methanol, reaction gases such as air or oxygen, reaction products such as water vapour or depleted fuels, or coolants such as water and/or glycol.

FIG. 2 shows, in a perspective view, two conventional bipolar plates 2, as can be used for example in electrochemical systems of the type shown in FIG. 1. FIG. 2 also shows a membrane electrode assembly (MEA) 10 arranged between these adjacent bipolar plates 2, the MEA 10 in FIG. 2 being largely obscured by the bipolar plate 2 facing towards the viewer. The bipolar plate 2 is formed of two separator plates 2a, 2b which are joined together in a materially bonded manner, of which in each case the first separator plate facing towards the viewer is visible in FIG. 2, said first separator plate obscuring the second separator plate. The separator plates may each be formed of a shaped metal sheet, for example of an embossed or deep-drawn stainless steel sheet. This metal sheet may for example have a thickness of at most 150 μm, for example at most 100 μm, for example at most 90 μm, for example at most 80 μm. The separator plates may be welded to one another, for example by laser welds.

The separator plates have through-openings which are aligned with one another, which form through-openings 11a-c and 11′ a-c of the bipolar plate 2. When a plurality of bipolar plates 2 are stacked, the through-openings 11a-c, 11′ a-c form media channels which extend through the stack of the system 1 in the stacking direction 7 (see FIG. 1). Typically, each of the media channels formed by the through-openings 11a-c, 11′a-c is fluidically connected to one of the ports 5 in the end plate 4 of the system 1. For example, coolant can be introduced into the stack via the media channels formed by the through-openings 11a and can be discharged from the stack via the through-openings 11′a. In contrast, the lines formed by the through-openings 11b, 11c may be designed to supply fuel and reaction gas to the electrochemical cells of the fuel cell stack of the system 1, while the lines formed by the through-openings 11′b, 11′c may be designed to discharge the reaction products from the stack.

The first separator plates have, on the front side thereof facing towards the viewer of FIG. 2, a flow field 17 with structures for guiding a reaction medium along the front side of the separator plate. The electrochemically active region 18 forms part of this flow field 17. In FIG. 2, these structures of the electrochemically active region 18 are defined by a plurality of webs 15 and by channels 16 extending between the webs 15 and delimited by the webs 15. On the rear sides of the channels, for example on the opposite surface of the separator plate, rear-side webs are formed, in the region of which the separator plates 2a, 2b bear against one another. On the front side of the bipolar plates 2, facing towards the viewer of FIG. 2, the first separator plates 2a additionally each have a distribution and collection region 20 for reaction medium, with a distribution and collection region for coolant (not visible) being located opposite this on the rear side of the separator plate 2a, for example on the inner side of the bipolar plate 2. The distribution region 20 comprises structures which are designed to distribute over the active region 18 a medium that is introduced into the distribution region 20 from a first 11b of the through-openings 11a, 11b, 11c, while the collection region 20 comprises structures which are designed to collect or to pool a medium flowing towards a first 11′b of the through-openings 11′a, 11′b, 11′c from the active region 18. To this end, the distribution and collection regions 20 have guide structures, which in FIG. 2 are defined by webs 14 and by channels 19 formed between the webs 14. The channels 16 may each be fluidically connected to one of the through-openings 11b, 11′b via the channels 19. The electrochemically active region 18 is thus fluidically connected to the through-openings 11b, 11′b via the distribution and collection regions 20.

The structures of the active region 18 and the guide structures of the distribution region 20 and of the collection region 20 are in each case formed in one piece with the separator plates 2a, 2b and are integrally formed in the separator plates 2a, 2b, for example in an embossing, hydroforming or deep-drawing process. The same usually applies to the corresponding guide structures on the second separator plates 2b.

Each of the through-openings 11a, 11′a has a sealing element 12a, 12′a that surrounds it. The region of the through-openings 11b, 11c, 11′b, 11′c and of the active region 18 and of the distribution and collection regions 20 are jointly surrounded by a sealing element 12d. The through-openings 11a, 11′a, 11b, 11′b, 11c, 11′c, the active region 18 and the distribution and collection region 20 together form the media-guiding inner region 21. Together, the sealing elements 12a, 12′a and 12d seal off the fluid-guiding region with respect to the non-media-guiding outer region 22.

By way of example, three elements 30, 31, 32 for individual cell voltage measurement (CVM) are formed in the outer region 22, these elements forming contact points 37, 38, 39. The two elements 30, 31 are integrally formed in the separator plates 2a, 2b as a socket 30, 31 of the contact points 37, 38. In contrast, the element 32 is designed as a plug-in element 32 of the contact point 39, which protrudes beyond the adjacent outer edge 24.

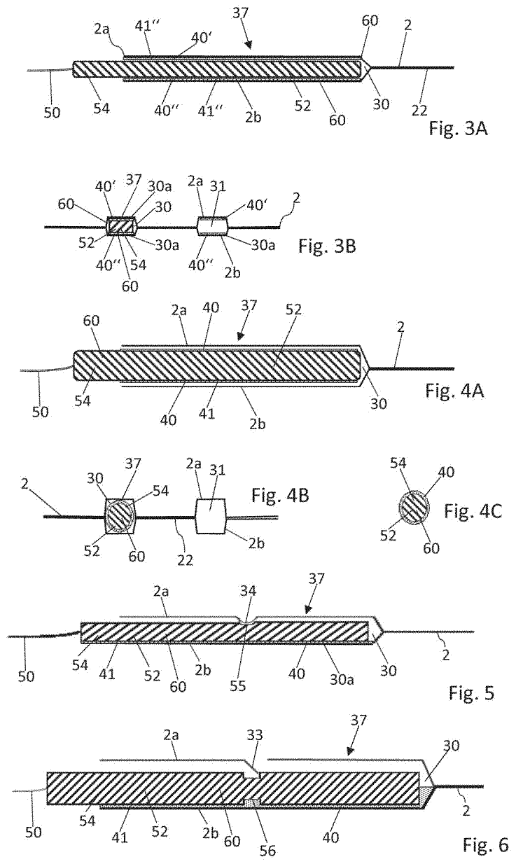

FIGS. 3 to 6 show different CVM measurement points comprising contact points and contact elements, as can be formed both in separator plates for bipolar plates and also in unipolar plates.

FIG. 3A shows a sectional view of a contact point 37 in the outer region 22 of a bipolar plate 2, which is comparable to the contact point 37 of FIG. 2. The two separator plates 2a, 2b of the bipolar plate 2 are in turn shaped in their outer region in a bead-like manner away from one another and thus define a socket 30. A plug-in element 54 of a contact element 52 of a transmission device 50, illustrated here in the form of a cable, is received in this socket 30. FIG. 3B shows a section perpendicular to the section of FIG. 3A; here, as in FIG. 2, a second socket 31 is present in addition to the socket 30. In the exemplary embodiment of FIGS. 3A and 3B, the plug-in element 52 is designed with a substantially rectangular cross-section.

FIGS. 4A and 4B show comparable sectional views of a contact point 37 with a plug-in element 54 received therein, as in FIGS. 3A-3B. Here, the plug-in element 54 is designed with an oval cross-section, as can also be seen from FIG. 4C.

FIG. 5 shows a sectional view through a contact point 37 of a bipolar plate 2 and a contact element 52 of a transmission device 50. This exemplary embodiment differs from that of FIGS. 3A and 3B in that a web-shaped embossment 34 is formed in the upper separator plate 2a in the region of the socket 30, said embossment engaging in a groove 55 on the upper side of the rectangular plug-in element 54 of the contact element 52 and thus may already bring about an improvement in the mechanical connection between the contact element 52 and the contact point 37.

FIG. 6 likewise shows a sectional view through a contact point 37 of a bipolar plate 2 and a contact element 52 of a transmission device 50. Compared to the exemplary embodiment of FIG. 5, now no embossment is provided in the separator plate 2, but instead a locking tab 33 is provided, which engages in a groove 56 that extends circumferentially around the surface of the round contact element 52. Compared to the exemplary embodiment of FIGS. 4A and 4B, this configuration might provide an improvement in the mechanical connection between the contact element 52 and the contact point 37.

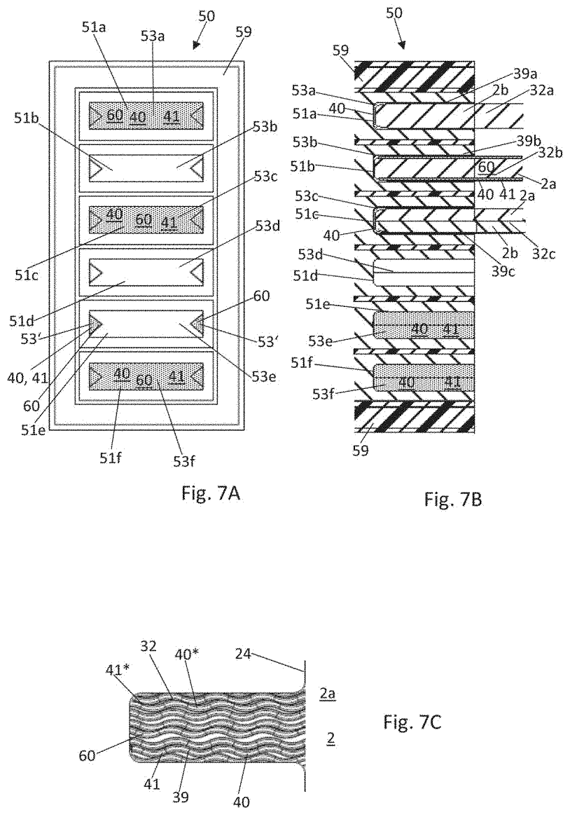

FIG. 7A shows a plan view of a transmission device 50 with six contact elements 51a-51f. The contact elements 51a-51f are each designed as sockets 53a-53f. The transmission device may have a frame 59 made of an electrically insulating polymer material, in which the actual sockets 53a-53f are held. FIG. 7B shows a sectional view of the transmission device of FIG. 7A with three plug-in elements 32a-32c of the contact points 39a-39c of separator plates received therein. The plan view of one such plug-in element 32 is shown in FIG. 7C, which also shows how the plug-in element 32 extends from the outer edge 24 of a separator plate 2a of a bipolar plate. FIG. 7B shows, in a manner not true to scale, that a plug-in element 32a, 32b may be formed in just one single plate 2b, 2a or, like the plug-in element 32c, may be formed of projections from both plates 2a, 2b of a bipolar plate.

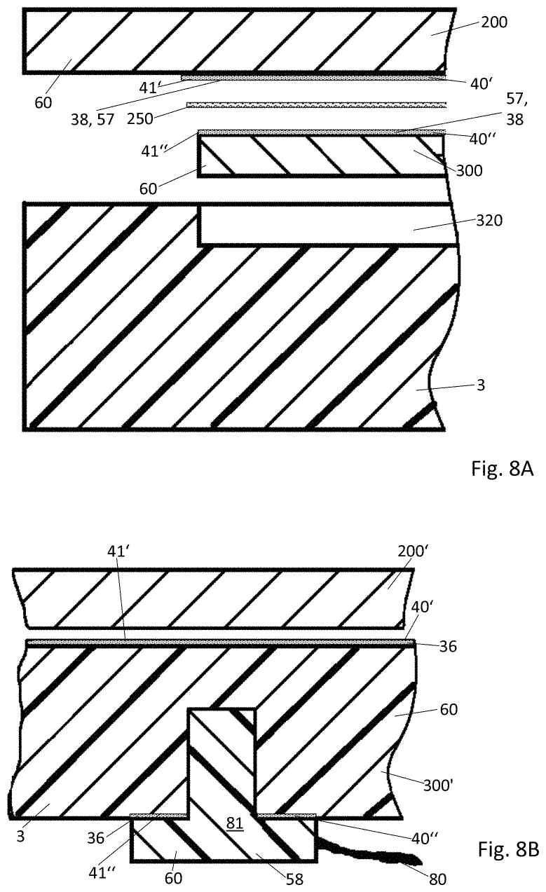

FIG. 8A shows a sectional view of part of an electrochemical system similar to the one shown in FIG. 1. Unlike in FIG. 1, the current collector plate 300 between the end plate 3 and the unipolar plate 200 is also visible here, as well as the recess 320 in the end plate 3, in which the current collector plate 300 can be accommodated. A contact layer 250, which may for example comprise a metal or graphite-fibre material comparable to a gas diffusion layer, may be accommodated between the unipolar plate 200, which is shown here in a simplified and unstructured form but nevertheless may have embossments in the same way as a separator plate of a bipolar plate, and the current collector plate 300. From a first perspective, the surface of the unipolar plate 200 acts as a contact point 38 and the surface of the current collector plate 300 acts as a contact element 57; from a second perspective, the surface of the current collector plate 300 acts as a contact point 38 and the surface of the unipolar plate 200 acts as a contact element 57.

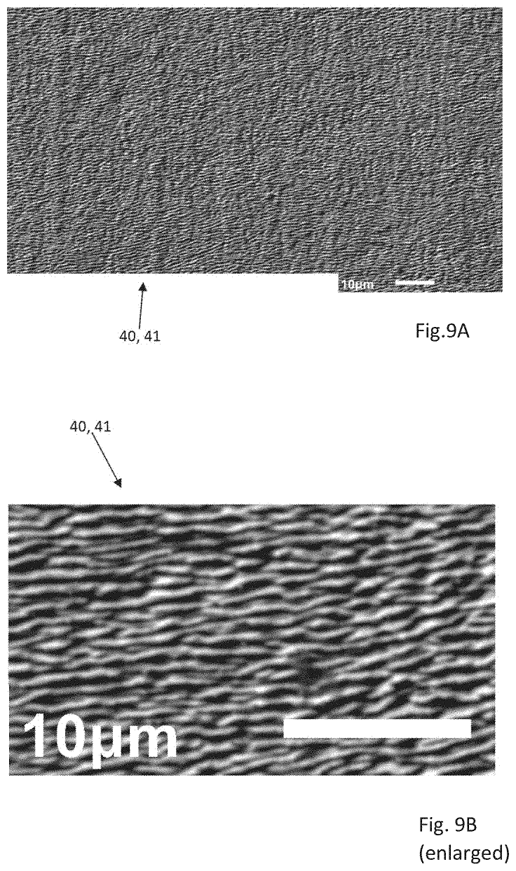

According to the present disclosure, the separator plates 2a, 2b of a bipolar plate 2 and/or the unipolar plate 200, 201 as a further separator plate and/or the current collector plate 300 and/or the contact element 51, 52, 57 and/or the transmission device 50, collectively an “article” 60, have at least in part a laser-surface-treated region 41, in which periodic surface structures 40 are formed with a mean spatial period of less than 10 The surface structures 40 are thus arranged at least in part at periodic intervals. The periodic surface structures 40 are created on the surface of the separator plate 2a, 2b by irradiation using an ultrashort-pulse laser. For instance, one contiguous region or multiple contiguous regions of the separator plate 2a, 2b may have the periodic surface structures 40. The periodic surface structures 40 will be further explained below with reference to FIGS. 9A to 10 and 12A to 12E.

FIG. 8B shows a sectional view of part of another electrochemical system, namely an electrolytic system. It shows an end plate 3 designed as a current supply plate 300′ as well as the first media distribution plate 200′ of an electrolyzer stack in a section distanced to the media conducts, thus in a non-media guiding region. In a simplifying manner, the media distribution plate 200′ in the section shown is depicted as a flat plate. However, it usually comprises channels on its surface facing away from the end plate, at one end of the stack for the distribution of water and the collection of oxygen and at the other end of the stack for the collection for hydrogen. In the same way as the unipolar plate 200 in FIG. 8A, the media distribution plate 200′ may also comprise structures, however, it at least in sections rests on the current supply plate 300′. FIG. 8B additionally shows a screw 81 taken up in the current supply plate 300′, which is connected to a current source via a cable 80. The current supply plate 300′ may be made from stainless steel. The media distribution plates may for instance be made from a titanium alloy or from a stainless steel, which may be coated at least in the media-guiding areas of its surface.

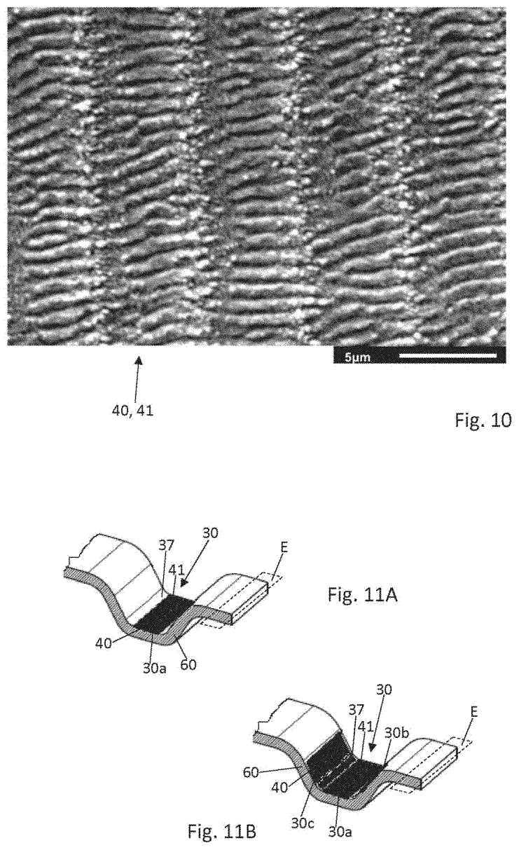

FIGS. 9A, 9B and 10 show greatly enlarged images of periodic surface structures 40, which are formed on the surface of a metal sheet, such as a stainless steel sheet, by a laser surface treatment and form at least one laser-surface-treated region 41 thereon. The enlarged parts may be parts of surfaces of a separator plate 2a, 2b, 200, 201, of a current collector plate 300, of a contact element 52, of a transmission device 50, or of a metal sheet for such an article 60. The stainless-steel sheet may be shaped by embossing, hydroforming or deep-drawing, and optionally punching, in order to form the article 60. Alternatively, the article 60 is first formed by embossing, hydroforming or deep-drawing, and optionally punching, and then is provided with the periodic surface structures 40. It is also possible for the surface structuring to be applied to the surface, or formed thereon, between two mechanical machining steps by means of irradiation with laser radiation.

While for a contact element 52 comprising a rectangular or substantially rectangular plug-in element 54, the periodic surface structures 40 may be present at least on two sides, such as on an upper side and a lower side, it is in contrast sufficient in some embodiments for the plates 2a, 2b, 200, 201, 300 if the periodic surface structures 40 are present only on one surface. In principle, the articles 60 may be provided with the periodic surface structures 40 at least in part on one and/or both sides. In the case of a plug-in element 54 having a round or oval cross-section, it is also possible to provide said plug-in element with the periodic surface structures 40 around the circumference.

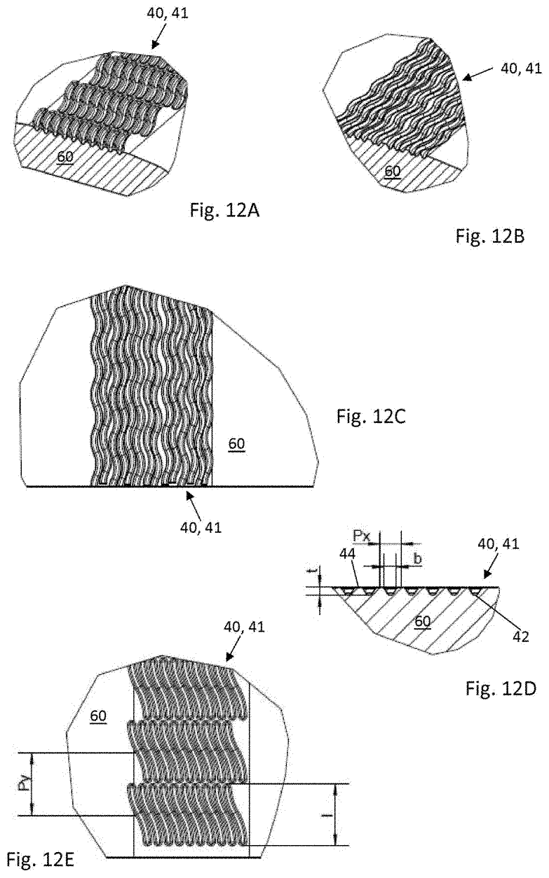

As can be seen from FIGS. 9A to 10 and 12A to 12E, the periodic surface structures 40 (hereinafter also surface structures 40) may comprise a plurality of depressions 42 and elevations 44. The depressions 42 extend between the elevations 44 and are delimited and/or formed by the latter. The surface structures 40 are arranged periodically with respect to one another in at least one spatial direction x, y. For instance, the surface structures 40 may be aligned with one another along their longitudinal direction. For example, the surface structures 40, that is to say the depressions 42 and the elevations 44, extend substantially parallel to one another. The surface structures 40 may be arranged in parallel one next to the other and/or one behind the other. For example, it can be seen in FIGS. 12B, 12C that the surface structures 40 are arranged in parallel one next to the other, for example perpendicular to the longitudinal direction of the surface structures. Furthermore, FIG. 10 shows that surface structures 40 can be arranged both in parallel one behind the other (one after the other in the longitudinal direction) and in parallel one next to the other. Such surface structures 40 can likewise be seen in FIGS. 12A and 12E.

The surface structures 40 may extend, for example, in a wavy or linear manner along their longitudinal direction. One example of the surface structures 40 extending in a wavy manner is shown in FIGS. 12B and 12C.

FIG. 12D shows a depth t, a width b and a period Px of the surface structures, for example of the depressions 42. The surface structures 40 may have a depth t of at least 8 nm, for example at least 50 nm, and/or at most 3 μm, for example at most 1 μm, for example at most 500 nm and/or at most 300 nm and/or at most 250 nm. In the present example, the depth is, for example, t=0.4 μm or t=100 nm. In one exemplary embodiment, the surface structures 40 have a width b, measured halfway up, of at least 0.1 μm and/or at most 2 μm. In the present example, the width is b=0.45 μm. In addition, the surface structures 40 may have a period Px in one spatial direction x of at least 0.3 μm and/or at most 3 μm. In the present example, the period is 1 μm. In FIG. 12D, the period Px denotes the lateral spacing between two adjacent elevations 44.

In FIG. 12E, the surface structures 40 have a length 1 of 5 μm in one spatial direction y. The surface structures are arranged in parallel one behind the other, with a period Py of 5 μm.

Owing to the surface structures 40, the surface of the article 60 has chemical and/or electrical properties that differ from regions of the article 60 without surface structures 40. For example, as a result of the surface structures 40, an oxygen content of the surface material of the article 60 may be greater in the region of the periodic surface structures 40 than outside of the periodic surface structures 40.

FIGS. 11A and 11B show, based on the example of two sockets 30, how the surfaces of separator plates can be provided with the periodic surface structures 40 in the region of a contact point 37. Said surface structures may for example be provided, as in the example of FIG. 11A, only on the base surface 30a of the socket 30, which extends substantially parallel to the plate plane E. However, they may for example also additionally be provided, as in the example of FIG. 11B, on the side walls 30b, 30c of the socket, which extend obliquely to the plate plane E.

In FIGS. 3A and 3B comparable surface structures 40′ and 40″ are provided on the base surfaces 30a of the sockets 30 and 31, as in the example of FIG. 11A. The surface structures may improve the conductivity.

In contrast, in FIGS. 4A to 4C, the surface structures 40 are formed around the circumference of a plug-in element 54 of a contact element 52, while the sockets 30, 31 are manufactured without a corresponding laser surface structure.

In the exemplary embodiment of FIG. 5, a surface structure 40 is formed only on the base surface 30a of the socket 30 of the separator plate 2b. By pressing the contact element 52 onto this base surface 30a by means of the locking embossment 34, good voltage transmission from the separator plate 2 to the transmission device 50 is thus achieved.

In contrast, FIG. 6 has the surface structure 40 on the entire inner side of the socket 30 of the separator plate 2b, but not on that of the separator plate 2a. Here, the surface structure 40 may result in an improvement in the voltage transmission compared to an analogous arrangement without such a laser treatment.

FIGS. 7A to 7C show, on the basis of a transmission device 50, different embodiments of CVM measurement points comprising plug-in elements 32 of the contact points 39 and sockets 53 of the contact element 51. Usually, a transmission device 50 has only identical sockets; here, the different embodiments are combined in one transmission device for illustration purposes. The sockets 53a, 53c and 53f are provided with a surface structure 40 across their entire surface, while the plug-in elements 32a and 32c received in the sockets 53a and 53c are designed with no surface structure. In contrast, the socket 53b, like the socket 53d as well, is free of any surface structure but receives a plug-in element 32b that is provided with a surface structure 40 on the upper side and lower side. The embodiment of socket 53e has a surface structure 40 only on its side faces 53′. The plan view of FIG. 7C shows a plug-in element 32 comparable to the plug-in element 32b. On this plug-in element 32, it is clear that an article 60 may have a plurality of laser-surface-treated regions 41, 41*, for example arranged at a distance from one another, and the respective surface structures 40, 40* may for example be phase-shifted relative to one another.

FIG. 8A shows a current collector plate 300, a unipolar plate 200, and an optional contact layer 250 arranged therebetween. In the exemplary embodiment shown, the unipolar plate 200 is designed as a smooth plate, but it may also have embossments and channels formed by the embossments; in this case, the webs between the channels bear directly or indirectly against the current collector plate 300, whereas in the exemplary embodiment shown there is a full-surface bearing across the entire extent of the current collector plate 300. Here, on their mutually facing surfaces, both the unipolar plate 200 and the current collector plate 300 are provided with a surface structure 40′ or 40″, respectively, across the extent of the area of the current collection plate 300. However, it would also be possible that just one surface, either that of the current collector plate 300 or that of the unipolar plate 200, is provided with such a surface structure 40′ or 40″.

In FIG. 8B, the surface of the endplate 3 pointing towards the media distribution plate 200′ is provided with a surface structure 40′ and this way shows a laser-surface-treated region 41′, which forms a contact point 38 to the media distribution area 200′, with the media distribution plate 200′ often being made from a titanium alloy. If the media distribution plate is however made from a stainless-steel sheet, which in most cases is coated in the media-guiding areas, then the media distribution plate 200′ might be provided with a surface structure 40′, while the surface of the endplate might or might not be surface structured.

The current supply plate 300′ on its surface pointing away from the media distribution plate 200′ may be provided—at least in sections—with a surface structure 40″, which forms a contact point 36 to the screw 81. This screw 81 enables the current provided via the cable 80 to enter into the system. As an alternative or in addition, it is possible that the screw 81 on its surface facing the endplate 3, such as its planar surface, is provided with a surface structure 40″ and this way forms a laser-surface-treated region 41″. The screw 81 here thus serves as contact element 58 and the contact area of the current distribution plate 300′ as contact point 36.

A method for producing an article 60 for an electrochemical system 1 will be disclosed below. The method may be suitable for producing one of the above-described plates 2a, 2b, 200, 200′, 201, 300 and 300′ and a contact element 51, 52, 57, 58.

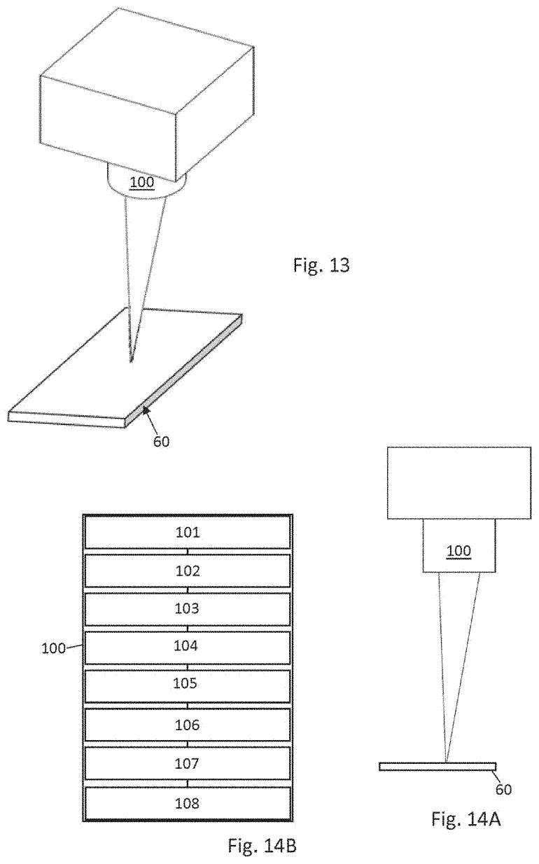

The method is characterized by a laser treatment using a laser 100 shown in FIGS. 13 and 14A. FIG. 14B shows some components of the laser 100, namely a laser head 101, a first mirror 102, a second mirror 103, a λ/2 plate 104, a polarizer, such as a linear polarizer, 105, a beam splitter 106, a shutter 107, and a lens 108. Of course, a different setup of the laser 100 is also possible.

For the method, a pulsed laser 100 may be used, wherein each pulse has a pulse duration of less than 1 ns, for example less than 100 ps. The laser 100 may therefore be a picosecond laser (pulse duration shorter than 1 ns and greater than or equal to 1 ps) or a femtosecond laser (pulses shorter than 1 ps, for example shorter than 500 fs and/or greater than or equal to 30 fs). The laser 100 may generate linearly polarized laser radiation. A beam diameter or a smallest lateral dimension of the laser parallel to the surface of the plate 2a, 2b, 200, 200′, 201, 300 and 300′ may be, for example, at least 20 μm and/or at most 2 mm, in the example shown approximately 60 μm. The wavelength λ, generated by the laser 100 lies, for example, between 200 nm and 2000 nm, for example between 400 nm and 1500 nm. Customary wavelengths are, for example, 700 to 1000 nm in accordance with a Ti:sapphire laser system; 1064 nm (fundamental wavelength) or 532 nm, 355 nm or 266 nm (frequency multiplication) in accordance with an Nd:YAG laser system. A fluence of the laser often depends on the material of the plate 2a, 2b, 200, 200′, 201, 300 and 300′ and may be, for example, at least 0.001, at least 0.01 or at least 0.1 and/or at most 10.0 J/cm², at most 5.0 J/cm², at most 2.0 J/cm². The repetition rate of the laser may be, for example, at least 10 Hz, for example at least 1 kHz, and/or at most 1000 kHz, for example at most 20 kHz.

Höhm 2014 includes a detailed description of the interaction of laser radiation with material to create periodic surface structures 40, with advantageous combinations of laser parameters also being published in Hohm 2014. For this reason, there is no need for any further description here.

In a first variant, the method comprises at least the following steps:

a method for producing a plate 2a, 2b, 200, 200′, 201, 300 and 300′ for an electrochemical, media-guiding system 1, comprising the steps:
providing a plate 2a, 2b, 200, 200′, 201, 300 and 300′
that has at least one contact point 36, 37, 38, 39 designed as a voltage take-off point or, as a current supply point, and/or one contact point 36, 37, 38, 39 designed as a current take-off point, which contact point is arranged in a non-media-guiding region 22 of the plate,
irradiating the contact point 36, 37, 38, 39 by means of a pulsed laser, a pulse duration of the laser pulses being less than 1 ns, for example less than 100 ps, for example less than 50 ps,
creating periodic surface structures 40 on the contact point 36, 37, 38, 39 by means of the laser radiation.

In a second variant, the method comprises at least the following steps:

a method for producing a contact element 51, 52, 57, 58 for mechanical and electrical connection to a contact point 36, 37, 38, 39 of a plate 2a, 2b, 200, 201, 300 and 300′ of an electrochemical system 1, the method comprising the steps:
irradiating the contact element 51, 52, 57, 58 by means of a pulsed laser, a pulse duration of the laser pulses being less than 1 ns, for example less than 100 ps, for example less than 50 ps,
creating periodic surface structures 40 on the contact element 51, 52, 57, 58 by means of the laser radiation.

In this second variant, when using a rotationally symmetrical plug-in element 54 of the contact element 52, during the irradiation, the laser beam may be moved and/or the rotationally symmetrical plug-in element 54 may be moved, for instance may be rotated about its axis of rotation.

The creation of this plurality of periodic surface structures 40 is already completed before the next laser pulse hits the surface of the plate 2a, 2b, 200, 201, 300 or 300′ or contact element 51, 52, 57, 58. For example, at least 10 or at least 20 surface structures, for instance trench structures, may be created per laser pulse. Typically, the surface structures 40 are oriented perpendicular to the linear polarization direction of the incident laser radiation. The laser 100 may therefore be directed onto a surface of the plate 2a, 2b, 200, 200′, 201, 300 or 300′ or of the contact element 51, 52, 57, 58 in such a way that surface structures 40 are created with a desired orientation. This may apply to the core regions of the irradiated region. When the laser pulse hits the surface of the plate 2a, 2b, 200, 200′, 201, 300 or 300′ or of the contact element 51, 52, 57, 58, the incident laser radiation interferes with an electromagnetic surface wave generated by the laser pulse in the surface material of the plate 2a, 2b, 200, 200′, 201, 300 or 300′ or of the contact element 51, 52, 57, 58. The periodic surface structures 40 are formed as a result of this interaction.

A mean spatial period Px of the surface structures 40 usually depends on the wavelength λ of the laser 100. For metals (metal sheet, stainless steel sheet), the period P is approximately in the order of magnitude of the wavelength λ. By way of example, the mean spatial period P of the surface structures 40 is at least 2%, for example at least 5%, for instance at least 20%, and/or at most 200%, for example at most 120% of the laser wavelength used.

In principle, a single laser beam is sufficient to create the surface structures 40. This laser beam can then scan the surface of the plate 2a, 2b, 200, 201, 300 or 300′ or of the contact element 51, 52, 57, 58 that is to be treated. In this case, the aforementioned plurality of periodic surface structures is created by each individual laser pulse within a spatial projection of the laser radiation onto the plate 2a, 2b, 200, 201, 300 or 300′ or the contact element 51, 52, 57, 58. The process can be accelerated if an interference pattern or diffraction pattern is formed by at least two laser beams, and the surface is scanned using the interference pattern in order to create the surface structures 40. To this end, a linearly polarized laser beam of the laser 100 may be split by way of the beam splitter 106. The two linearly polarized partial beams thereby produced are then used to form the interference pattern. The interference pattern of the laser beams that is used serves to enlarge the scanned surface area and has no direct influence on the periodicity of adjacent surface structures 40. The spatial period of the surface structures 40 thus differs from the spatial period of the interference pattern or diffraction pattern and is usually significantly smaller, for example 10 times smaller. However, comparative measurements have shown that, by means of this surface structuring applied in an accelerated way, the volume resistance cannot be reduced to the same extent as when using just one single laser beam. As an alternative or in addition, a line laser (also called a linear laser) may also be used, the laser line thereof may have a width of at least 20 μm.

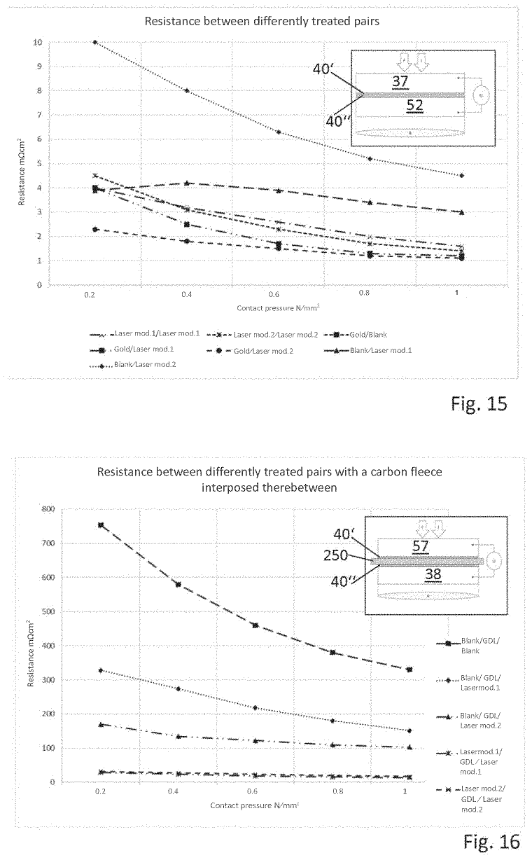

FIG. 15 shows the results of resistance measurements at the transition point between two stainless steel sheets, for example between a contact point 32 and a contact element 52, comparable to the situation at a CVM measurement point. The stainless-steel sheets have no surface structuring (“blank”) or different surface structuring or coatings. It is obvious that the two combinations involving a blank stainless-steel sheet have the highest contact resistance. The contact resistances between laser-surface-treated stainless steel sheets, or between laser-surface-treated stainless-steel sheets and gold-coated stainless-steel sheets, are approximately equal, such as at higher contact pressures, while the laser-surface-treated stainless-steel sheets have significantly lower manufacturing costs.

FIG. 16 shows the results of resistance measurements at the transition point between two stainless steel sheets with a carbon fleece 250 arranged therebetween, for example between a contact point 38 and a contact element 57, comparable to the situation between a unipolar plate 200 and a current collector plate 300. The stainless-steel sheets have no surface structures (“blank”) or different surface structures introduced by laser treatment. The pairing of two blank stainless-steel sheets leads to a very high contact resistance, whereas already significantly lower contact resistances are measured when a blank stainless-steel sheet is combined with a laser-surface-treated stainless-steel sheet. The lowest contact resistances are achieved when two laser-surface-treated stainless steel sheets are combined.

The resistance measurement results shown in FIGS. 15 and 16 indicate that, both for a voltage measurement point and for a current take-off point, a reduced contact resistance and an improved conductivity at the contact area are achieved when the contact point 36, 37, 38, 39 and/or the contact element 51, 52, 57, 58 is laser-surface-treated, compared to when using untreated sheet surfaces.

FIGS. 1-14A show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

It will be appreciated that the configurations and routines disclosed herein are exemplary in nature, and that these specific embodiments are not to be considered in a limiting sense, because numerous variations are possible. Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

As used herein, the term “approximately” or “substantially” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. An electrochemical, media-guiding system, comprising:
a plate, wherein the plate is a separator plate, a media distribution plate, a current supply plate or a current collector plate, and
at least one contact point forming a voltage take-off point, a current supply point, and/or a current take-off point, wherein the at least one contact point has a laser-surface-treated region and is arranged in a non-media-guiding region of the plate.

2. The system according to claim 1, wherein the plate is a separator plate comprising:
a media-guiding inner region,
a non-media-guiding outer region, and
at least one sealing element which seals off the media-guiding inner region with respect to the non-media-guiding outer region,
wherein the contact point is provided in the outer region.

3. The system according to claim 1, wherein the contact point is electrically and mechanically, connected to a transmission device and the connection is force-fit and/or form-fit.

4. The system according to claim 3, wherein the contact point forms a socket for a plug-in element of the transmission device or forms a plug-in element for a socket of the contact element of the transmission device.

5. The system according to claim 1, wherein the contact point is a flat, substantially planar, region that extends at least in part along a flat side of the plate.

6. The system according to claim 1, further comprising a contact element for electrical and mechanical, force-fitting and/or form-fitting, connection to a contact point of the plate, wherein the contact element has a laser-surface-treated region.

7. The system according to claim 6, wherein the contact element is a plug-in element for a socket of the contact point of the plate or as a socket for a plug-in element of the plate.

8. The system according to claim 6, further comprising a transmission device for use in measuring an electrical voltage and/or in transmitting an electrical current onwards from at least one sub-region of an electrochemical system.

9. The system according to claim 1, wherein the laser-surface-treated region has periodic surface structures with a mean spatial period of less than 10 μm.

10. The system according to claim 9, wherein the surface structures comprise depressions, which extend substantially parallel to one another.

11. The system according to claim 10, wherein the depressions have a depth of at least 8 nm, and/or at most 0.5 μm, a width of at least 0.1 μm and/or at most 2 μm, and/or a period in one spatial direction of at least 0.3 μm and/or at most 3 μm.

12. The system according to claim 9, wherein the surface structures are at least in part arranged periodically in relation to one another at least in one spatial direction.

13. The system according to claim 9, wherein an electrical conductivity is greater in the laser-surface-treated region than outside of the laser-surface-treated region.

14. The electrochemical system according to claim 1, comprising a plurality of stacked separator plates, which are arranged between a first current collector plate and a second current collector plate.

15. The electrochemical system according to claim 14, comprising a transmission device.

16. The electrochemical system according to the claim 1, comprising a plurality of stacked media distribution plates, which are arranged between a first current supply plate and a second current supply plate.

17. A method for producing a plate for an electrochemical, media-guiding system, comprising the steps:
providing a plate that has at least one contact point forming a voltage take-off point, a current supply point, and/or a current take-off point, and the at least one contact point arranged in a non-media-guiding region of the plate,
irradiating the contact point using a pulsed laser with a pulse duration of less than 1 ns,
creating periodic surface structures on the contact point using the laser radiation.

18. A method for producing a contact element for mechanical and electrical connection to a contact point of a plate of an electrochemical system, the method comprising the steps:
irradiating the contact element using a pulsed laser with a pulse duration of less than 1 ns,
creating periodic surface structures on the contact element using the laser radiation.
